(19) United States
(12) Patent Application Publication
(10) Pub. No.: US 2025/0326645 A1
(43) Pub. Date: Oct. 23, 2025

(54) Flame Synthesis of Carbon-Based Films on Liquid Surfaces

(71) Applicant: Rutgers, The State University of New Jersey, New Brunswick, NJ (US)

(72) Inventors: Stephen D. Tse, Warren, NJ (US); Chuiyuan Meng, New Brunswick, NJ (US); Bernard H. Kear, Whitehouse Station, NJ (US); Jonathan Shi, New Brunswick, NJ (US); Kristina Cheng, New Brunswick, NJ (US)

(21) Appl. No.: 19/182,912

(22) Filed: Apr. 18, 2025

Related U.S. Application Data
(60) Provisional application No. 63/635,933, filed on Apr. 18, 2024.

(51) Int. Cl. C01B 32/205; C01B 32/05

(52) U.S. Cl. CPC C01B 32/205; C01B 32/05; C01P 2002/02; C01P 2002/52; C01P 2002/82; C01P 2002/85; C01P 2004/03; C01P 2004/04

(57) ABSTRACT

Methods for the production of films, particularly carbon-based films, based on gas-phase deposition on a liquid surface, and the products fabricated by the methods are provided.

The present application claims priority to U.S. Provisional Application No. 63/635,933, filed Apr. 18, 2024. The entire disclosure of the foregoing application is incorporated by reference herein.

This invention was made with government support under Grant Nos. W911NF-17-1-0111 and W911NF-22-2-0205 awarded by the Army Research Office.

The government has certain rights in the invention.

### FIELD OF THE INVENTION

This invention describes methods for the synthesis of films, particularly carbon-based films, and the products produced thereby.

### BACKGROUND OF THE INVENTION

Flame synthesis has a demonstrated history of scalability and offers the potential for high-volume continuous production at reduced costs (Kammler, et al. (2001) Chem. Eng. Technol. (2001) 24:583-96). In utilizing globally-rich combustion, a fraction of the hydrocarbon reactant generates the requisite elevated temperatures, with the balance of fuel serving as the hydrocarbon reagent for carbon-based structure growth, thereby constituting an efficient method of synthesis. This aspect can be especially advantageous as the operating costs for producing advanced materials, particularly in the semiconductor industry, end up far exceeding the initial capital equipment costs. Flame synthesis has been used successfully to grow various oxide nanostructures, single-wall and multiwall carbon nanotubes (CNTs), sheet-like carbon particles, and amorphous carbon thin-films (Xu et al. (2007) Chem. Phys. Lett., 449:175-81; Xu, et al. (2006) Appl. Phys. Lett., 243(88):113-5; Height, et al. (2004) Carbon 42:2295-307; Xu, et al. (2006) Carbon 44:570-7; Ossler, et al. (2010) Carbon 48:4203-6; Li, et al. (2011) Carbon 49:237-41). Few-layer graphene has also been synthesized with flames using alcohol as fuel on a substrate (Li, et al. (2011) Chem. Commun., 47:3520-2). Although the viability of flame synthesis to grow graphene was demonstrated, the process resulted in the formation of amorphous carbon impurities along with the graphene. Moreover, the configuration may not be readily scalable for large-area graphene production.

Improved methods for the production of films (including those of novel composition, microstructure, and morphology) by substrate-free methods are needed.

### SUMMARY OF THE INVENTION

In accordance with the instant invention, methods for synthesizing a film, particularly a carbon-based film, are provided. In certain embodiments, the method comprises reacting an oxidizer and a fuel in a burner with the flame directed at a liquid surface. In certain embodiments, the method comprises directing plasma at a liquid surface. In certain embodiment, the fuel comprises or consists of a hydrocarbon. In certain embodiments, the flow velocity and/or distance from the burner to the liquid surface may be varied to affect film characteristics.

The burner of the instant methods may be configured in any known way. For example, the burner may be configured as a gaseous non-premixed, gaseous premixed, gaseous partially premixed, droplet spray, solid particle aerosol flame, or combination thereof. In certain embodiments, the burner is a multiple, inverse-diffusion flame burner.

In certain embodiments, the film is organic, inorganic, or a mixture. In certain embodiments, the film is organic (e.g., comprises a hydrocarbon). In certain embodiments, the film is polymeric, crystalline (e.g., nanocrystalline), and/or amorphous. In certain embodiments, the film comprises particles, flakes, granules, fibers, wires, and/or sheets. The films of the instant invention may range in thickness from micrometers to nanometers to angstroms. In certain embodiments, the film has a thickness in the nanometer range.

In certain embodiments, the oxidizer is air, O₂, or another oxidizing agent. In certain embodiments, the oxidizer is oxygen, optionally with an inert gas such as N₂, Ar, or He. In certain embodiments, the oxidizing agent is a halogen. In certain embodiments, the oxidizing agent is fluorine, chlorine, bromine, or iodine.

In certain embodiments, the fuel is a hydrocarbon, combustible liquid, combustible solid fuel, or other combustible gas. The fuel may also be the precursor. In certain embodiments, the fuel is a hydrocarbon (e.g., ethylene or acetylene). In certain embodiments, the fuel is selected from the group consisting of methane, natural gas, methanol, gasoline, diesel, JP-8 (a kerosene-based fuel), and biofuels. In certain embodiments, the fuel is a mixture of methane and another hydrocarbon (e.g., ethylene or acetylene).

The precursor may be seeded into the burner. Multiple precursors can be delivered. Precursors can be a gas, liquid, solid, or a combination thereof. The resultant pyrolysis vapors are carried by the flow and directed onto the liquid surface where they are quenched to form films. In certain embodiments, the pyrolyzed precursor species exiting the burner are quenched to generate nanostructured particles by a vapor condensation mechanism, which deposit currently with film growth.

The liquid surface may be chemically non-participating or chemically participating in the formation of the film. In certain embodiments, the liquid surface is chemically non-participating, such as water (although water may provide hydroxyl radicals into the gas phase). In certain embodiments, the liquid surface may be chemically participating, such as hydrocarbon, serving as another precursor source. In certain embodiments, the liquid surface comprises a surfactant. In certain embodiments, the liquid surface is rotated. In certain embodiments, the liquid surface is perturbed, such as by ultrasound. In certain embodiments, the liquid is flowing during deposition (e.g., such that films can move on the liquid surface in a continuous production mode).

The films of the instant invention may comprise an additive such as an inert, dopant (e.g., metal, rare earth), and/or other reactant. For example, the additive may be added to the method such that the pyrolysis vapors contain the additive, thereby forming doped films (e.g., doped carbon-based films). In certain embodiments, the inert, dopant, and/or other reactant are introduced at a level different than the first level of a multiple, inverse-diffusion flame burner.

### BRIEF DESCRIPTIONS OF THE DRAWING

FIG. 1 provides a schematic of an ethylene-air premix honeycomb-flow flame impinging on the liquid surface of a distilled water bath, producing carbon-based films on the liquid surface.

FIG. 2 provides a schematic of flame synthesis on liquid surfaces in various solution baths, producing doped carbon-based, inorganic, and organic/inorganic films.

FIG. 3 provides an image of a carbon-based film deposited on the liquid surface of a distilled-water bath by honeycomb-flow burner. Different shades of grey are different colors produced by visible light interference from the thin film.

FIG. 4 provides a visual mapping of the film structure deposited by honeycomb-flow burner.

FIG. 5 provides images of a carbon-based film under optical microscope, showing different domains of thickness, as inferred from the different colors (shown as shades of grey).

FIG. 6A provides Raman spectrum from as-synthesized film. FIG. 6B provides Raman spectrum of turbostratic carbon (Wollbrink, et al. (2016) Carbon 106:93-105). FIG. 6C provides Raman spectra of graphitic nanostructures.

FIG. 7A provides a Fourier-Transform infrared spectroscopy (FTIR) characterization of graphite, GO and rGO (Strankowski, et al. (2016) J. Spectroscopy 2016:7520741; Kanta, et al. (2017) J. Nanomaterials 2017:2758294). FIG. 7B provides a FTIR characterization of an as-synthesized film by flame synthesis on liquid surface. The widespread presence of oxygen bonds explains its hydrophilic nature.

FIG. 8A provides field emission scanning electron microscopy (FESEM) images of as-synthesized carbon-based films without surfactant. FIG. 8B provides FESEM images of as-synthesized carbon-based films with surfactant.

FIG. 9 provides a high-resolution transmission electron microscopy (HRTEM) image of flame synthesis product, showing fully-amorphous structure.

FIG. 10 provides an HRTEM image of flame synthesis product, showing quasicrystal/polycrystal structure with non-periodic pattern.

FIG. 11 provides an image of the formation of the carbon-based film on a liquid substrate by tube burner.

FIG. 12A provides a dynamic series of images of growing carbon-based film on the liquid surface of a distilled-water bath by tube burner with timestamps. FIG. 12B provides a close view of as-synthesized carbon-based film from FIG. 12A. Different shades of grey are different colors produced by visible light interference from the thin film.

FIG. 13A provides FESEM images of gut-like wrinkle pattern on carbon-based films. FIG. 13B provides FESEM images of nano-to-micro wrinkle transition pattern on as-synthesized carbon-based films.

FIG. 14 provides FESEM images of both sides of the wrinkle pattern on as-synthesized carbon-based films, showing its 2D structure.

FIG. 15A provides FESEM images of as-synthesized carbon-based film deposited with dense large coarse particles. FIG. 15B provides FESEM images of as-synthesized carbon-based film deposited with sparse tiny smooth particles. FIG. 15C provides FESEM images of as-synthesized carbon-based film deposited with giant smooth particles.

FIG. 16 provides FESEM images of curled as-synthesized carbon-based film with both wrinkles and tiny smooth particles.

FIG. 17 provides FESEM images of inner structure of a cracked as-synthesized carbon-based film.

FIG. 18 provides a FESEM image of thickness measurement of the as-synthesized carbon-based film, showing a minimum of <20 nm thickness.

FIG. 19 provides an HRTEM image of flame synthesis product, showing incipient soot structure.

FIG. 20 provides an atomic force microscopy (AFM) image of as-synthesized carbon-based film, showing ultrasmooth surface and deposited particles.

FIG. 21 provides a polarization curve of as-synthesized carbon-based film, showing extremely high resistivity.

FIG. 22A provides an X-ray photoelectron spectroscopy (XPS) survey of as-synthesized carbon-based film, showing high oxygen content ratio. FIG. 22B provides two XPS C1s scans of different positions of as-synthesized carbon-based film, showing high sp3 ratio on both spots.

FIG. 23 provides an X-Ray-Excited Auger electron spectroscopy (XAES) characterization on different positions of as-synthesized carbon-based film same to FIG. 22, showing different sp3 ratio on different spots.

FIG. 24 provides a schematic of a dielectric barrier discharge (DBD) non-equilibrium plasma generator, showing power supply, zero voltage switching (ZVS) driver, transformer, and plasma reactor.

FIG. 25A provides images of the plasma-synthesized carbon-based film on a liquid substrate by DBD non-equilibrium plasma with helium and ethylene. FIG. 25B provides an image of plasma-synthesized carbon-based film with Helium and ethylene under optical microscope, showing different domains of thickness, as inferred from the different colors (shown as shades of grey).

FIG. 26A provides images of the plasma-synthesized carbon-based film on a liquid substrate by DBD non-equilibrium plasma with argon and acetylene. FIG. 26B provides an image of plasma-synthesized carbon-based film by DBD non-equilibrium plasma with argon and acetylene under optical microscope, showing different domains of thickness, as inferred from the different colors (shown as shades of grey).

FIG. 27 provides a FTIR characterization of the plasma-synthesized film by DBD non-equilibrium plasma synthesis on liquid surface.

FIG. 28 provides a XAES characterization of the plasma-synthesized film by DBD non-equilibrium plasma synthesis on liquid surface.

### DETAILED DESCRIPTION OF THE INVENTION

Herein, methods for the fabrication of thin films via combustion without the need for a solid substrate are provided. Additionally, the methods of the instant invention do not require the use of a strong acid. More specifically, a novel flame process has been developed to produce films on liquid surfaces. Generally, the method comprises directing a flame at a liquid surface (e.g., such that the sooting and/or pre-sooting zone reaches the water surface). In certain embodiments, the method comprises reacting an oxidizer and a fuel in a burner with the flame directed at a liquid surface (e.g., depositing pyrolysis vapors and/or species on to the liquid surface). In certain embodiments, the combustion is fuel-rich. In certain embodiments, plasma is directed at a liquid surface. In certain embodiments, the liquid-substrate-based flame synthesis (LS-FS) method utilizes water (e.g., high purity water) as substrate for deposition and a premixed flame jetted onto the water surface to rapidly get quenched, thereby depositing a novel carbon-based film on the water surface. In certain embodiments, the films (e.g., when extracted) are essentially or completely substrate-free films.

The resultant films can have a variety of different characteristics. In certain embodiments, the films are turbostratic. In certain embodiments, the films are amorphous. In certain embodiments, the films are polymeric. In certain embodiments, the films are crystalline (e.g., nanocrystalline). The films can be organic, inorganic, or a mixture of both. In certain embodiments, the films are organic. In certain embodiments, the films are carbon-based films. In certain embodiments, the films are inorganic (e.g., by utilizing inorganic precursors). In certain embodiments, the films are a combination of organic and inorganic (e.g., by using respective precursors in tandem). For simplicity, the films of the instant invention will generally be described as carbon-based films. However, as explained above, the films can be inorganic or a mixture of organic and inorganic components.

As stated hereinabove, the films can be turbostratic. Current methods to produce turbostratic carbon generally include using dry ice and Mg particles as substrates. This leaves behind MgO impurities that are nearly impossible to remove and affect film properties and require extra purification steps (Cuadros-Lugo, et al. (2022) Materials 15:2501). The present methods do not require the use of dry ice or seed particles, thereby bypassing these impurities.

The films produced by the methods of the instant invention can range in thickness from micrometers to nanometers to angstroms. In certain embodiments, the film is in the nanometer range. In certain embodiments, the thickness of the film is about 1 nm to about 1000 nm, about 100 nm to about 900 nm, about 1 nm to about 900 nm, about 10 nm to about 1000 nm, about 1 nm to about 800 nm, about 1 nm to about 500 nm, about 10 nm to about 500 nm, about 20 nm to about 500 nm, or about nm to about 300 nm. In certain embodiment, the thickness of the film is less than about 1000 nm, 900 nm, 800 nm, 700 nm, 600 nm, 500 nm, 400 nm, 300 nm, 200 nm, or 100 nm. In certain embodiment, the thickness of the film is more than about 1 nm, 5 nm, 10 nm, 15 nm, 20 nm, 25 nm, 30 nm, 50 nm, or 100 nm. In certain embodiments, the film is a monolayer. In certain embodiments, the film is a bilayer. In certain embodiments, the film is multilayer. The films of the instant invention can have a variety of different characteristics and may not be a pristine sheet, although it can be. In certain embodiments, the film comprises a coating, particle, granule, fiber, wire, preform, composite, polymer, film, disc, plate, sheet, and/or flake. In certain embodiments, the film comprises a particle, flake, granule, fiber, wire, and/or sheet. In certain embodiments, the film comprises wrinkles. In certain embodiments, the film is smooth. Smooth films can be readily formed during short depositions (e.g., less than 60 seconds) or in areas away from the flame center.

In certain embodiments, the film comprises particles, particularly on the surface of the film. Particle size may be increased with longer deposition times. In certain embodiments, the diameter (e.g., average diameter) of the particles is in the nanometer range. In certain embodiments, diameter (e.g., average diameter) of the particles is about 1 nm to about 1000 nm, about 1 nm to about 750 nm, about 1 nm to about 500 nm, about 1 nm to about 250 nm, about 1 nm to about 200 nm, or about 1 nm to about 100 nm. In certain embodiment, the diameter (e.g., average diameter) of the particles is less than about 1000 nm, 900 nm, 800 nm, 700 nm, 600 nm, 500 nm, 400 nm, 300 nm, 200 nm, or 100 nm. In certain embodiment, the diameter (e.g., average diameter) of the particles is more than about 1 nm, 2 nm, 3 nm, 4 nm, 5 nm, nm, 20 nm, 50 nm, or 100 nm.

In certain embodiments, the method utilizes gaseous hydrocarbons (e.g., ethylene) as both fuel and precursor gas burning in premixed mode. However, other methods can be employed such as, without limitation: gaseous diffusion flame and spray flame. For example, the burner may be configured as a gaseous non-premixed, gaseous premixed, gaseous partially premixed, droplet spray, solid particle aerosol flame, or combination thereof. Furthermore, the method can utilize other gas-phase processes such as, without limitation, plasma (either equilibrium or non-equilibrium), with the source precursor being gas, liquid, or solid.

In certain embodiments, the burner is operated in an ambient-air environment or an inert environment (e.g., an inert gas such as N₂, Ar, and/or He), with or without a containing chamber. In certain embodiments, the burner is in continuous operation. The burner may operate in open and closed environments and at different pressures. In certain embodiments, the burner operates at a temperature greater than about 300° C., greater than about 400° C., greater than about 500° C., greater than about 600° C., greater than about 700° C., greater than about 800° C., or greater than about 900° C.

In certain embodiments, the burner generates flames with a sooting zone (e.g., a premixed sooting zone and/or pre-sooting zone). In certain embodiments, the burner is a tube burner. In certain embodiments, the burner is a honeycomb burner.

In certain embodiments, the burner is a diffusion flame burner. In certain embodiments, the burner is a multiple, inverse-diffusion flame burner. Multiple, inverse-diffusion flame burners are described, for example, in WO 2012/116286, incorporated by reference herein. The burner comprises an array of tiny, stabilized flames that form a uniform flat-flame front, with respect to substrates placed well downstream. Each of the diffusion flames is run in the inverse mode (“under-ventilated”). Generally, for each tiny stabilized flame of the burner, the oxidizer (e.g., air, oxygen, etc.) is provided by a center feed tube and the fuel (e.g., hydrogen or a hydrocarbon precursor such as ethylene, acetylene, etc.) is provided by tubes which surround it.

Examples of fuel that can be used in the methods of the instant invention include, without limitation: a hydrocarbon, combustible liquid, combustible solid fuel, or other combustible gas. In certain embodiments, the fuel is selected from the group consisting of methane, natural gas, methanol, gasoline, diesel, JP-8, and biofuels. As indicated herein, the fuel may also be the precursor. In certain embodiments, the fuel is a hydrocarbon. In certain embodiments, the fuel is a hydrocarbon such as ethylene, acetylene, or mixes thereof. In certain embodiments, the fuel is a C1-C3 hydrocarbon, particularly a C2-C3 hydrocarbon. In certain embodiments, the hydrocarbon is unsaturated. In certain embodiments, the fuel is ethylene.

In certain embodiments, the oxidizer is air, oxygen (O₂), or another oxidizing agent. The oxygen can be diluted to any desired concentration with an inert gas (e.g., N₂, Ar, and/or He). The inert gas can also serve as the dopant species. Examples of other oxidizing agent include, without limitation: halogens such as fluorine, chlorine, bromine, and iodine.

In certain embodiments, plasma is used. In certain embodiments, the plasma is a non-equilibrium plasma. In certain embodiments, a dielectric barrier discharge plasma is used. In certain embodiments, the plasma gas is helium. In certain embodiments, the precursor (gas) is ethylene. In certain embodiments, the plasma is used alone or is used with or assisting a combustion process.

In certain embodiments highly reactive radical species are produced from starting molecular precursors (e.g., through electron-impact dissociation, where energetic electrons collide with gas molecules). In certain embodiments, spectroscopy is used to monitor the gas-phase profile prior to deposition to optimize or control the radical species concentrations for specific film growth. In certain embodiments, film growth and/or formation is monitored (e.g., by using spectroscopy).

The films of the instant invention may comprise one or more additives, such as an inert, dopant, and/or other reactant. In certain embodiments, the films are doped and/or alloyed. For example, methods of synthesizing films with nitrogen and/or boron, as well as other elements, is also encompassed by the instant invention. For example, ammonia (NH₃) can be introduced with the hydrocarbon fuel to provide a source of nitrogen, such that the NHₓ species formed during flame decomposition are incorporated directly into the film. Similarly, borane (BH₃) or borane-ammonia (H₃NBH₃) can be introduced with the hydrocarbon fuel to provide a source of boron and/or nitrogen.

The methods of the instant invention comprise deposition on a liquid surface. In certain embodiments, the liquid surface is chemically non-participating in the formation of the film. In other words, the liquid surface provides a support but does not become a substantial part of the film. Examples of chemically non-participated liquids include, without limitation: water, distilled water, ultrapure water (UPW), high-purity water, and the like. In certain embodiments, the liquid comprises or consists of an organic solvent (e.g., alcohol or ethanol). In certain embodiments, liquid surface is chemically participating in the formation of the film. In other words, chemicals from the liquid surface add to and become part of the deposited film. Examples of chemically participating liquids include, without limitation: another precursor, hydrocarbons, and the like. In certain embodiments, the liquid comprises a surfactant. In certain embodiments, the liquid comprises a dopant such as, without limitation: a metal, organic, and/or inorganic.

Variations in the liquid surface affects the produced films. In certain embodiments, the liquid surface is still, motionless, immobile, undisturbed, and/or unperturbed. In certain embodiments, the liquid surface is altered during the deposition process. For example, the liquid surface may be rotated during deposition. Rotating the liquid substrate (e.g., spin coating) can maintain flatness and uniformity of the films. In certain embodiments, the liquid surface is disturbed and/or perturbed during deposition (e.g., by mixing, stirring, vibrating, and/or applying sonication and/or ultrasonication).

In certain embodiments, the method of the instant invention is a continuous synthesis method (e.g., thereby allowing the synthesis of large films). In certain embodiments, the liquid surface flows in a direction away (e.g., horizontally) from the burner during deposition. In other words, the liquid substrate flow may simulate a conveyer belt away from the burner for formation of the film, thereby enabling continuous fabrication, with methods to remove the film from the surface. In certain embodiments, the burner is moved, oriented, and/or rasterized over and/or across the liquid surface during deposition. A monitoring system (e.g., Raman spectra and/or photoluminescence) may follow the formed films to assess the quality of the films.

The distance from the flame to the liquid surface can be varied to modulate the properties of the produced film. In certain embodiments, the distance between the flame and the liquid surface remains constant throughout the deposition. In certain embodiments, the distance between the flame and the liquid surface is varied during the deposition. Operating distances can vary a based on the flow velocity. As an example, for a 1.5 mm diameter nozzle with a total flow rate 500 mLpm for a premixed ethylene/oxygen flame of equivalence ratio 3, working distances of about to about 20 mm, particularly about 12-15 mm readily forms a carbon-based film. In certain embodiments, the distance is from about 1 mm to about 100 mm, about 5 mm to about 50 mm, about 5 mm to about 25 mm, about 10 to about 20 mm, or about 10 mm to about 15 mm.

The instant invention also encompassed the films produced by the methods described herein. The films of the instant invention can be durable and/or strong. As explained herein, the films have a number of advantages over films synthesized on a solid substrate and can be used in any field for any application as an otherwise produced film could be used. For example, the films produced by the methods of the instant invention can be used as a conductive coating or membrane (e.g., for electrochemical application). In certain embodiments, the films produced by the methods of the instant invention can be used in electronic applications. In certain embodiments, the films produced by the methods of the instant invention can be used in thermal applications. In certain embodiments, the films produced by the methods of the instant invention can be used in photovoltaics. In certain embodiments, the films produced by the methods of the instant invention can be used in displays. In certain embodiments, the films produced by the methods of the instant invention can be used in product, material, or composite strengthening. In certain embodiments, the films produced by the methods of the instant invention can be used in energetic materials or propellants.

### Definitions

The singular forms “a,” “an,” and “the” include plural referents unless the context clearly dictates otherwise.

As used herein, a “surfactant” refers to a surface-active agent, including substances commonly referred to as wetting agents, detergents, dispersing agents, or emulsifying agents. Surfactants are usually organic compounds that are amphiphilic. In certain embodiments, the surfactant is anionic. In certain embodiments, the surfactant is cationic. In a particular embodiment, the surfactant is an amphiphilic copolymer or an amphiphilic block copolymer. In a particular embodiment, the surfactant is sodium dodecyl sulfate (SDS). In a particular embodiment, the concentration of the surfactant ranges from about 0.1% to about 10%.

As used herein, the term “amphiphilic” means the ability to dissolve in both water and lipids/apolar environments. Typically, an amphiphilic compound comprises a hydrophilic portion and a hydrophobic portion.

The following example describes illustrative methods of practicing the instant invention and is not intended to limit the scope of the invention in any way.

### EXAMPLE

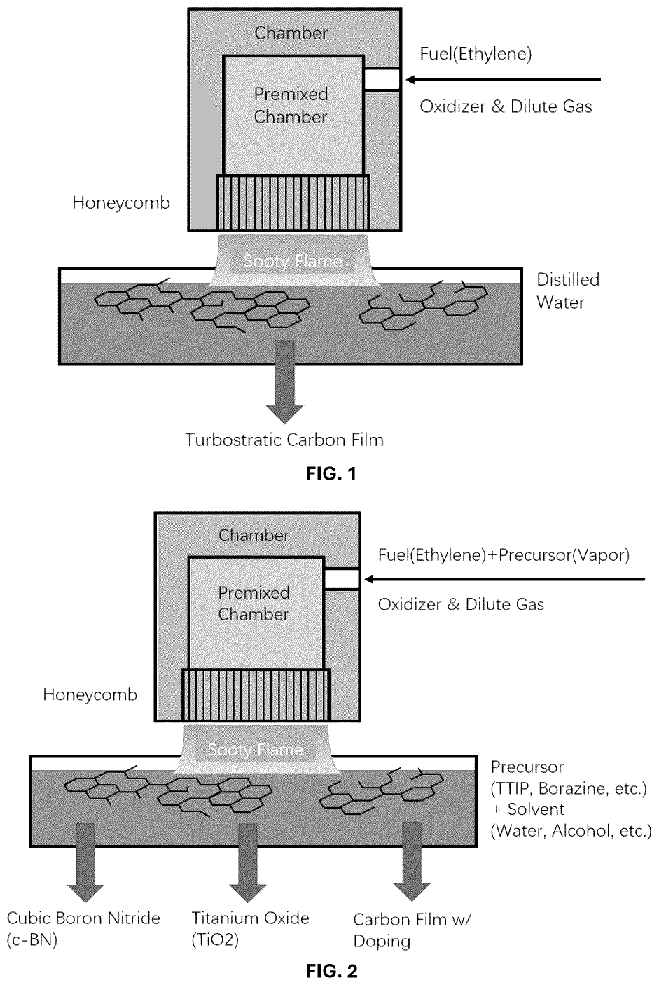

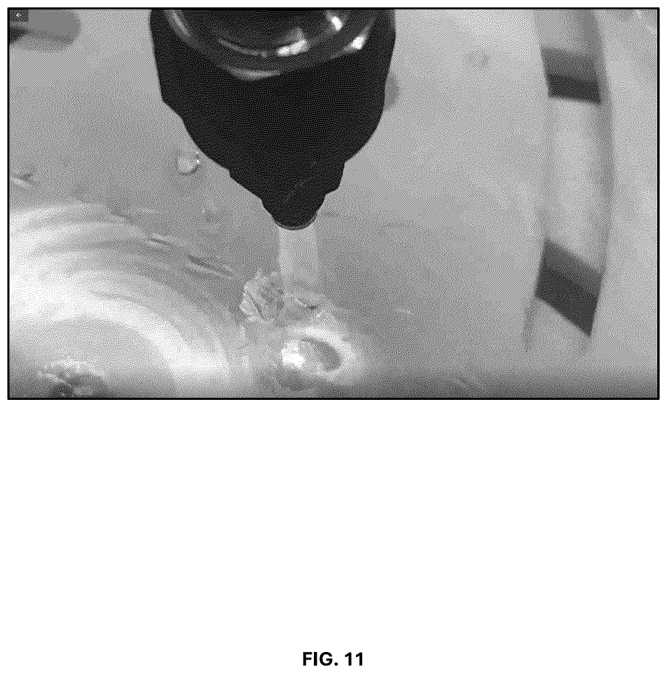

FIG. 1 provides a schematic of a lab-scale implementation of the present methods for producing carbon-based films. As an example, FIG. 1 depicts the use of an ethylene-air premixed honeycomb-flow flame directed at a distilled-water bath. FIG. 11 provides an image of the formation of the carbon-based film. In certain embodiments, a platform is utilized to precisely adjust the distance between the burner exit and the surface of the liquid (e.g., water bath). Subsequent deposition of the flame products and intermediates on the liquid surface leads to the nucleation and growth of carbon-based films. Typically, the resultant films exhibit a thickness range from tens of nanometers to several hundred nanometers for the process durations tested (e.g., from 30 seconds to a few minutes).

An example of experimental parameters using ethylene are: fuel flow rate: 0.08-0.11 standard liters per minute (SLPM), air flow rate: 0.39-0.42 SLPM, equivalence ratio: 2.8-4.0 (fuel-rich), and duration: 30 seconds-600 seconds.

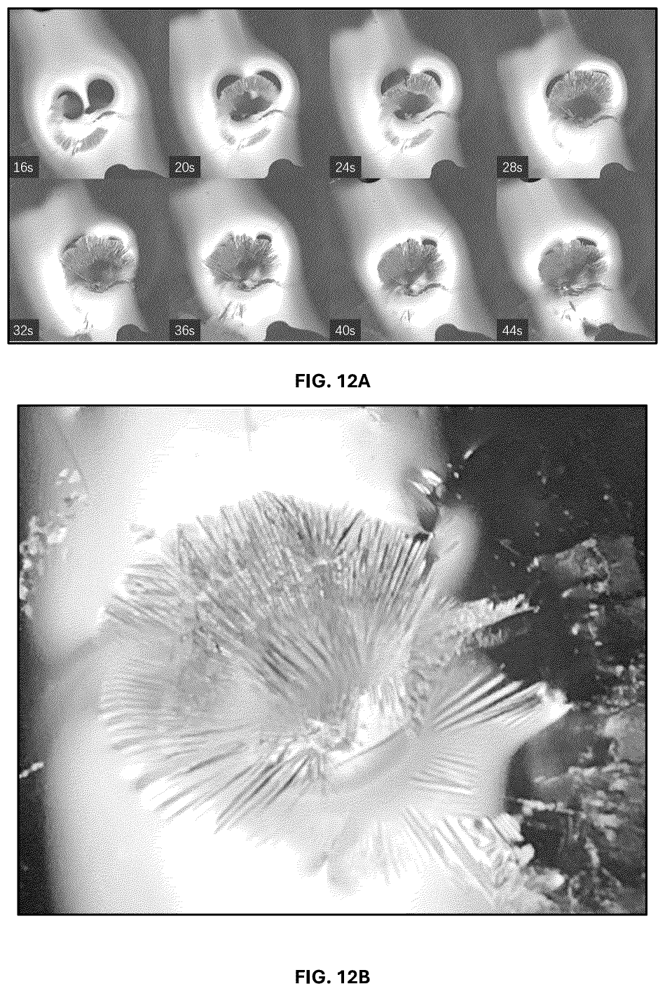

Films can start to form within about 10 or 20 seconds. In FIG. 12A, a synthesis process by a tube burner shows the dynamic growth of film. At 16 seconds, a transparent ultrathin film covering the whole water surface could be observed by its reflection to light. A close look in FIG. 12B shows the transition between the transparent region and the colored region, demonstrating the gradual growth of the film.

Preliminary experimental results demonstrate that the incorporation of a surfactant into the liquid can affect the uniformity and edge sharpness of the carbon-based film produced by the methods of the instant invention. Without being bound by theory, this effect may be attributed to the reduction of the surface tension by the surfactant. The results indicate that this approach holds tremendous potential for producing continuous, large-scale, uniform carbon-based films.

As stated hereinabove, the apparatus and method of the instant invention can produce metal/non-metal doped carbon-based nanofilms. As shown in FIG. 2, the method involves introducing precursors into the burner, with the reactants, or into the liquid. This approach enables the production of carbon films with (e.g., doped with) metal (e.g., titanium) and/or other materials.

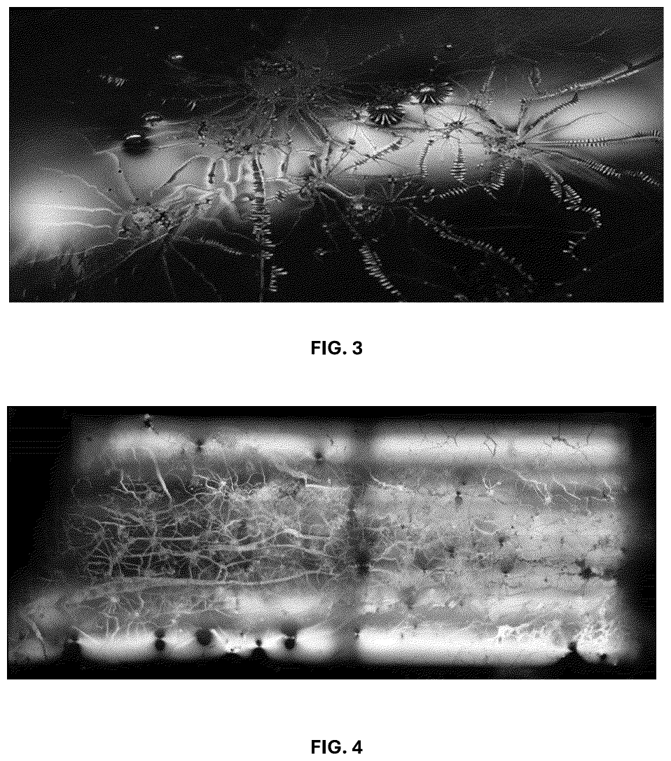

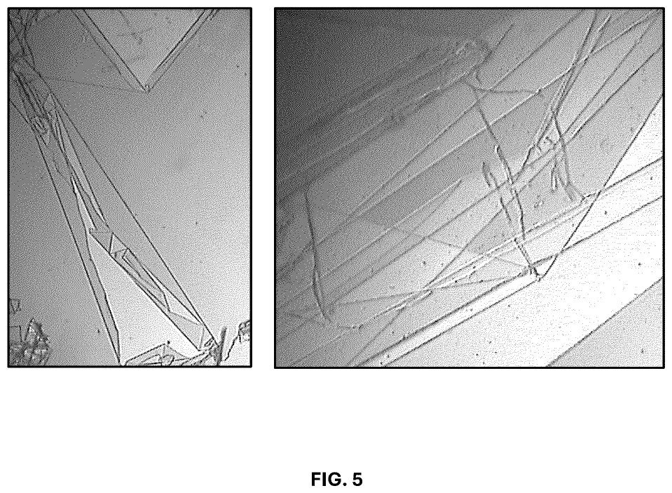

The film characteristics revealed by optical microscopy are illustrated in FIGS. 3, 4, and 5. The images reveal domain structures with sharp and straight edges and folded patterns. Uniform films can be achieved by controlling the flame and liquid surface characteristics. The rapid and controlled formation of these films can produce materials with unique properties that can be exploited in a variety of applications.

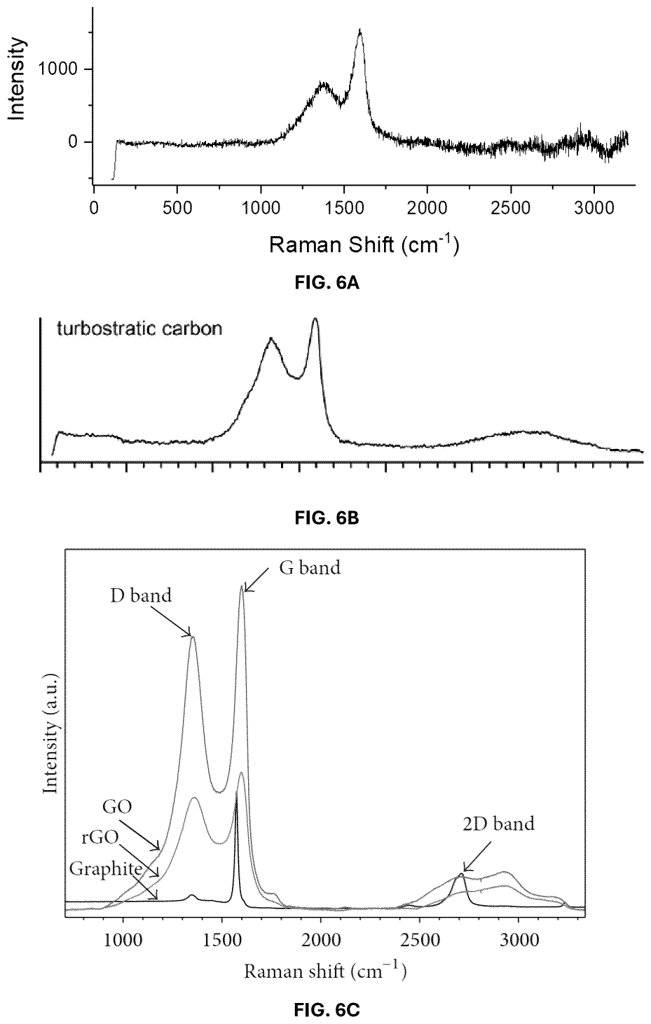

Preliminary Raman spectroscopy of an as-synthesized carbon-based film is presented in FIG. 6. The results show some similarities to turbostratic carbon. The spectrum exhibits a strong D and G peak and a weak signal over the 2D peak, signifying the sp2 hybridization that characterizes the graphitic structure. Comparison with graphene oxide (GO) and reduced graphene oxide (rGO) show similarities. Amorphous carbon films are also observed.

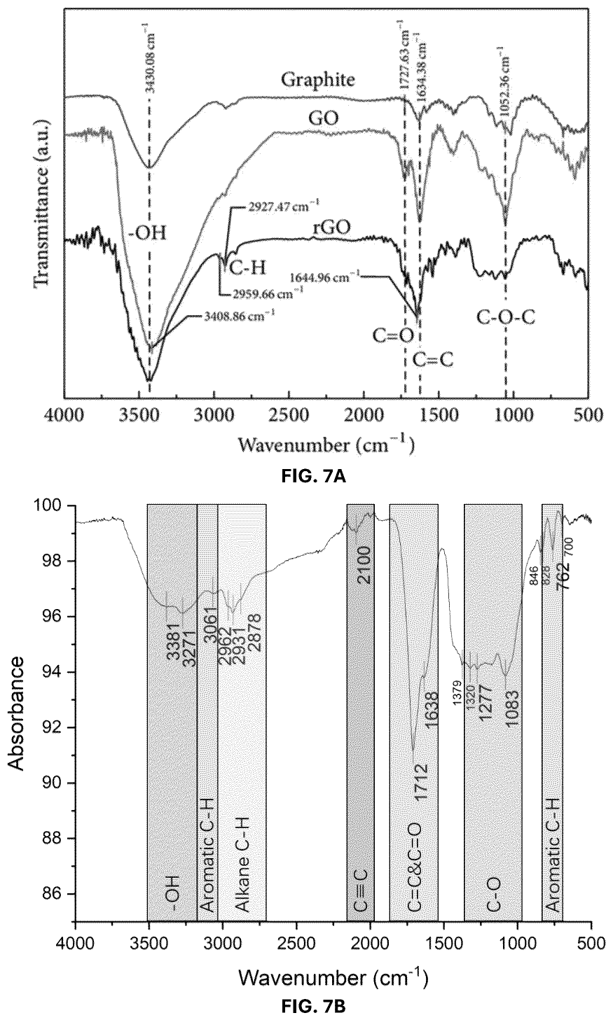

The Fourier-Transform Infrared spectroscopy (FTIR) analysis is shown in FIG. 7. The results show the composition of the produced carbon-based film and its similarities with graphene oxide. The results demonstrate the presence of aromatic and other complex structures in the film.

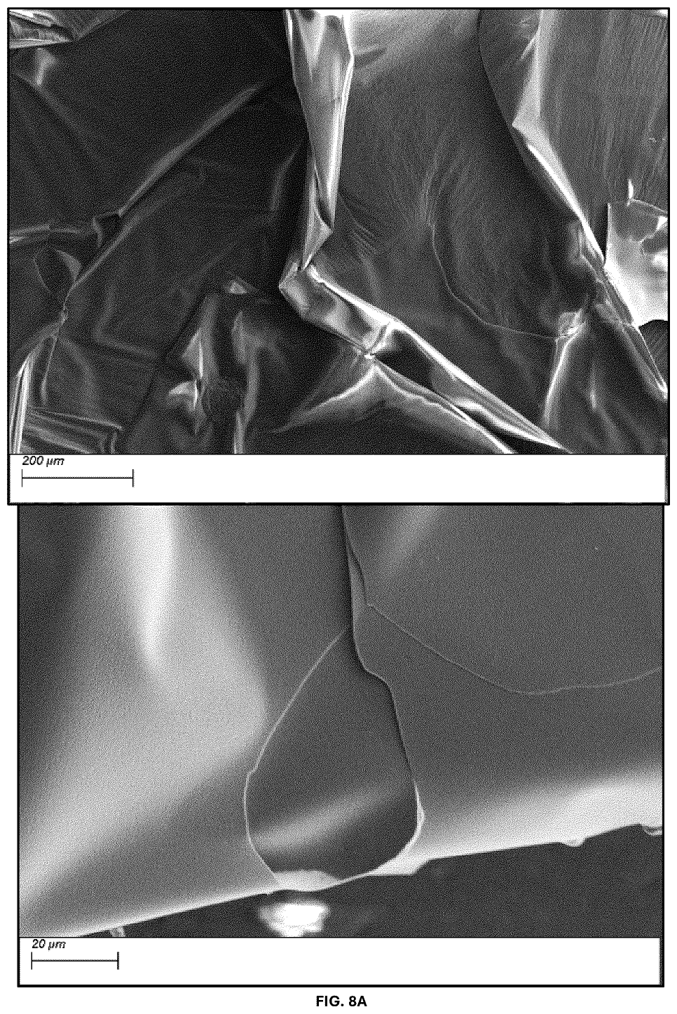

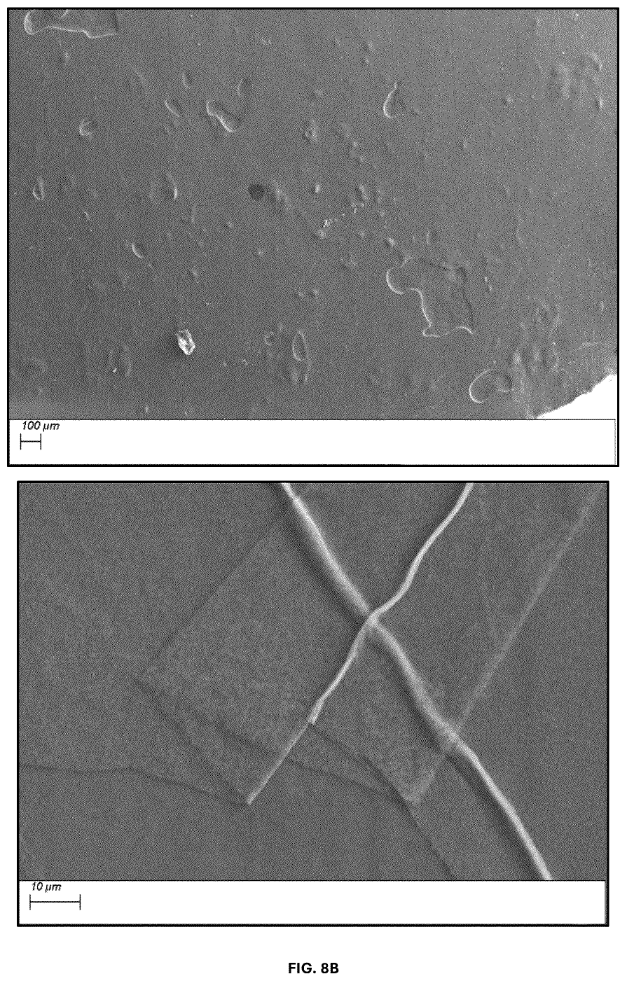

Field emission scanning electron microscopy (FESEM) was also used to characterize the morphology of the product—with and without the surfactant. The obtained images are presented in FIG. 8. FIG. 8A displays the morphology of the product obtained without the surfactant, which exhibits folds and wrinkles on the film surface. In another image, a smooth and uniform surface structure can be observed. FIG. 8B shows the morphology of the product obtained with the surfactant. The film is relatively flat and exhibits negligible thickness compared to the roughness of the carbon tape used in the experiment. A closer examination reveals that adding a surfactant to the water surface significantly affects the film morphology. In this case, the film exhibits fewer folds and wrinkles.

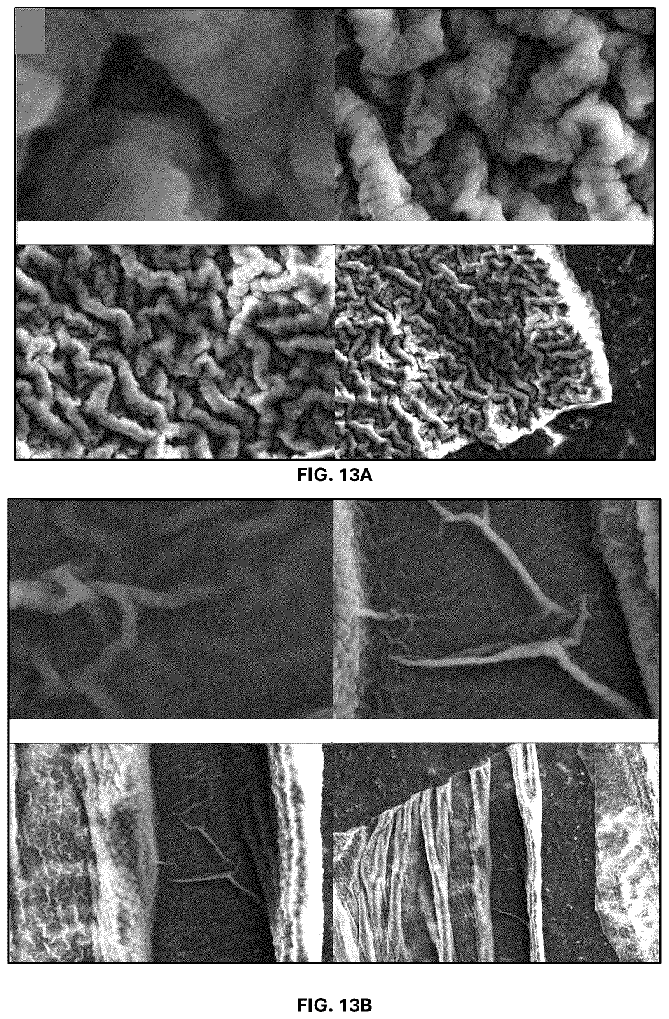

FESEM results with larger magnification further reveals the various morphologies and structures exist in the product. Wrinkle-like patterns such as the “gut-like” features in FIG. 13A appear three-dimensional but are, in fact, distortions of a 2D film surface, as confirmed in FIG. 14, which shows both sides of the film in a single frame. The transition of wrinkle formation is depicted in FIG. 13B, where a flat surface progressively curls into structures, likely due to thermal contraction and water-induced vibrations during synthesis. Mechanical handling during sample collection also contributes to wrinkle development. Notably, despite these complex morphologies, the film remains uniformly thin on the micron scale.

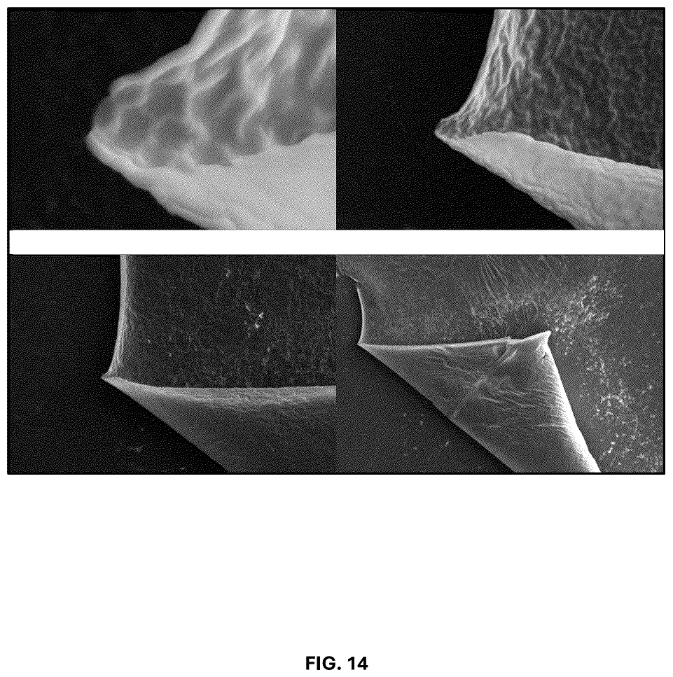

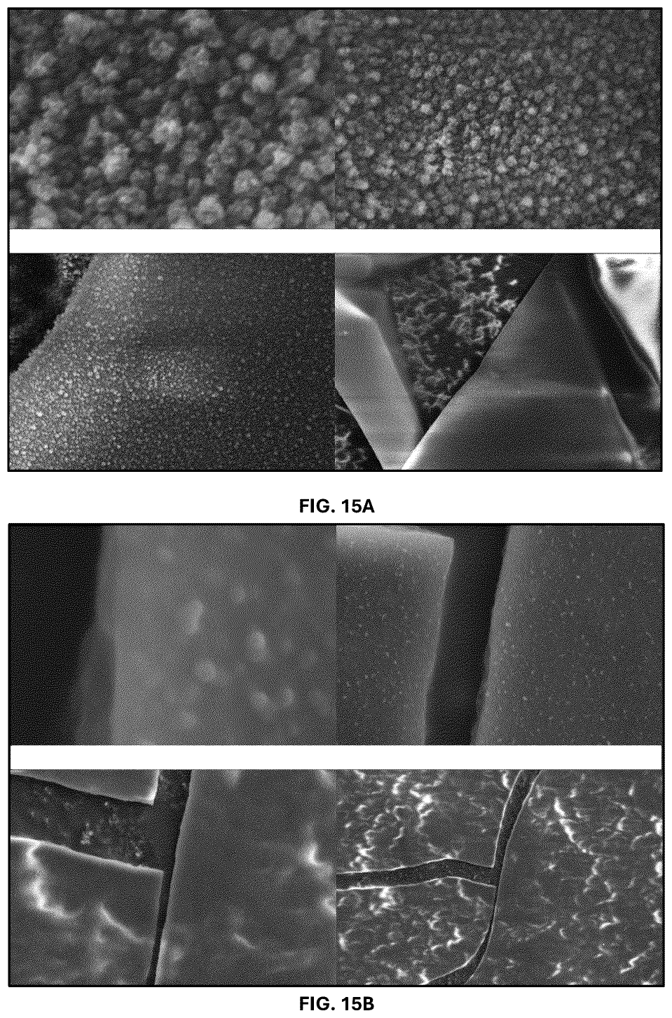

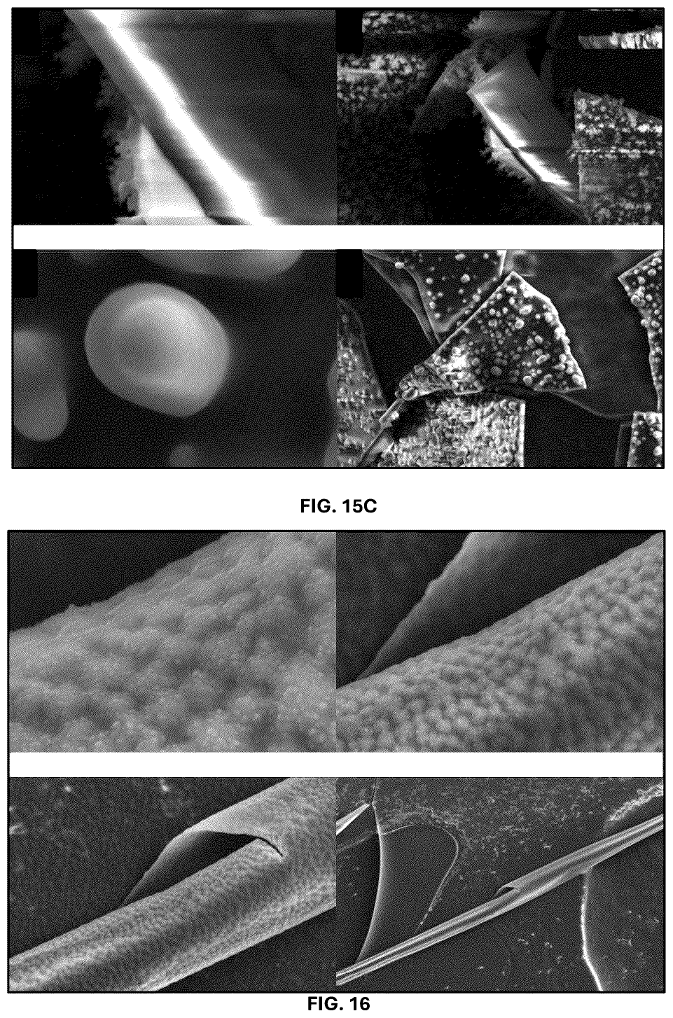

Distinct regions of the film also show particle deposition, with the characteristics strongly influenced by the film's position relative to the flame center. In FIG. 15A, dense and morphologically diverse soot particles are seen on a sample taken closer to the flame, while FIG. 15B shows only small, round particles farther away. Increased deposition time or equivalence ratio leads to thicker films with larger soot features and sometimes tree-like growths, as illustrated in FIG. 15C. These thicker films exhibit low conductivity and electron beam-induced image distortion. Generally, the resistivity of the material is extremely high, as determined by conductive atomic force microscopy (c-AFM).

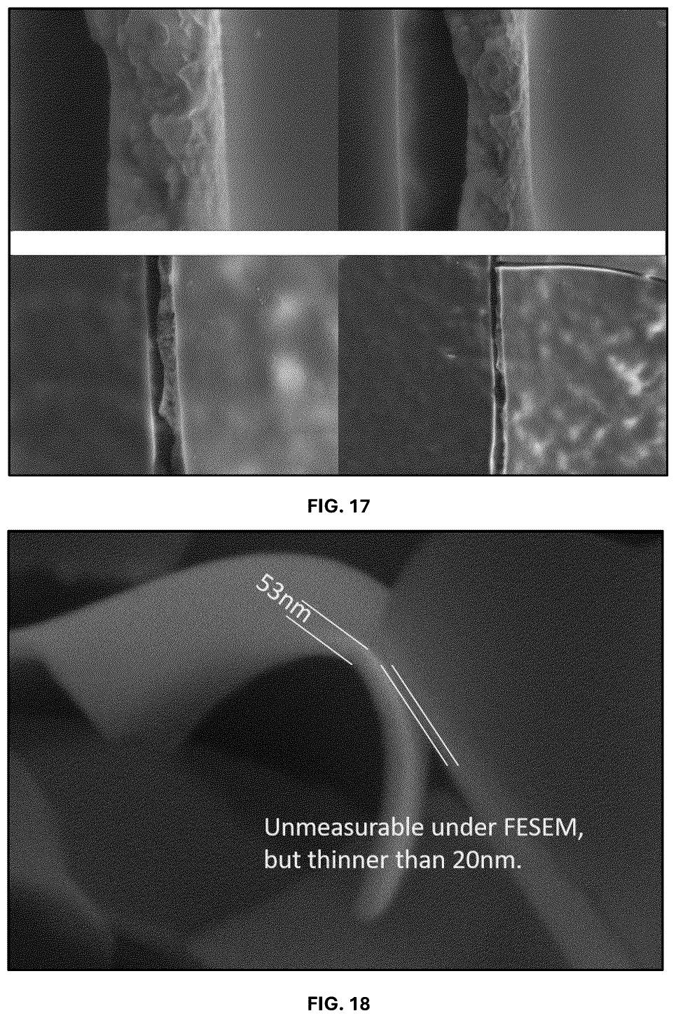

In some samples, both wrinkles and particle deposition coexist. FIG. 16 presents a typical film with nanometer-scale particles, pox-like wrinkles, and micron-scale curls, all of which confirm the elasticity and 2D nature of the film. Even the reverse side shows mirrored structures, indicating structural uniformity. The inner structure of thick films, as revealed in FIG. 17, shows broken inner layers rather than a continuous stratified morphology, likely due to environmental instabilities during synthesis. Lastly, film thickness can range from over 300 nm to less than 20 nm, as shown in FIG. 18 where ultra-thin films become nearly invisible under FESEM due to their strong adhesion to the substrate.

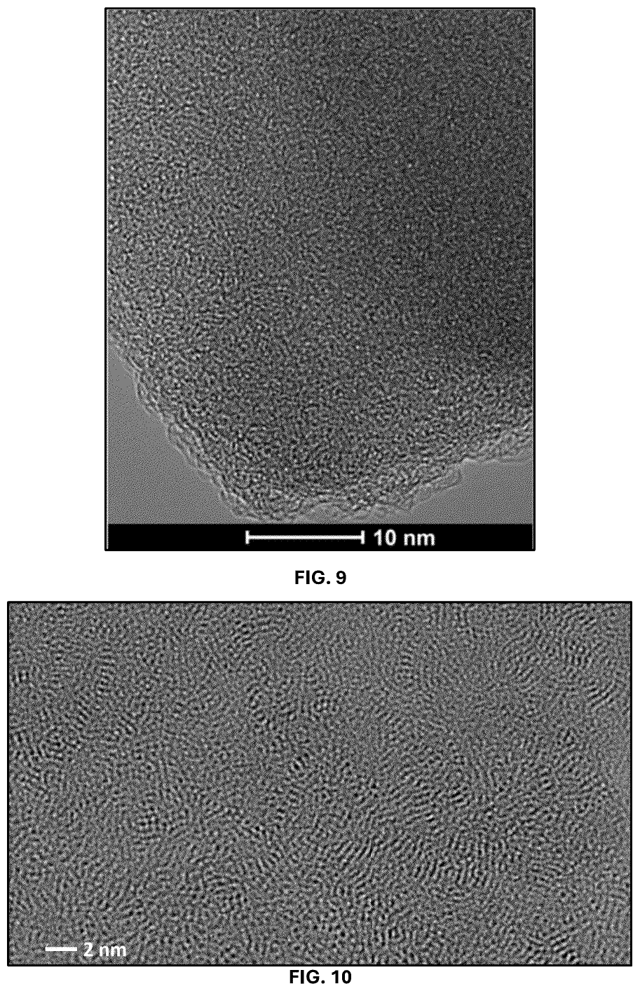

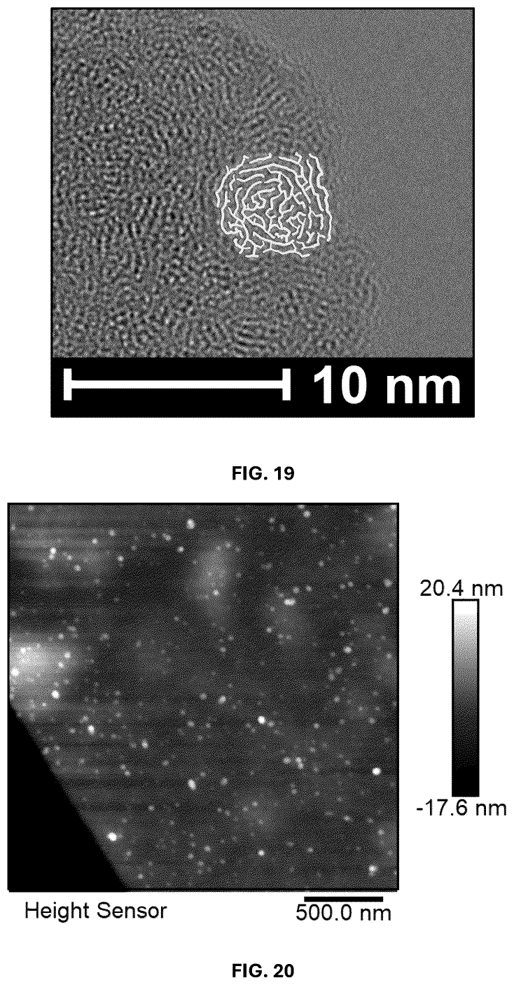

The Transmission Electron Microscopy (TEM) characterization of an as-synthesized film is presented in FIG. 9. The results show the presence of multilayer films with a uniform arrangement. FIG. 10 shows a high-resolution TEM (HRTEM) of an as-synthesized film, showing possible quasicrystal/polycrystal structure with non-periodic pattern. FIG. 19 reveals the existence of incipient soot within the as-synthesized film, suggesting the carbon-based film formation mechanism is involved with formation of incipient soot.

The Atomic Force Microscopy (AFM) characterization of an as-synthesized film is presented in FIG. 20. Root Mean Square (RMS) roughness of the film is 2.15 nm, and the thickness is 142 nm. AFM shows the ultra-smoothness of the film and measures the film thickness with high accuracy.

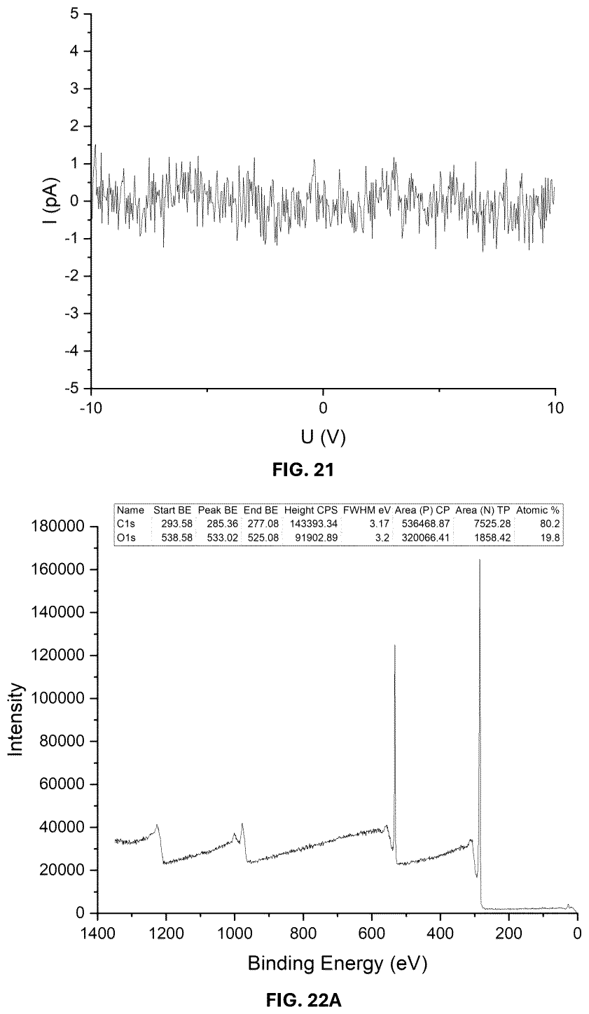

The polarization curve of an as-synthesized film as presented in FIG. 21 shows its extremely high resistivity. With a bias voltage of −10V to 10V, it is unable to measure any noticeable current with a minimum sensitivity of 1 pA.

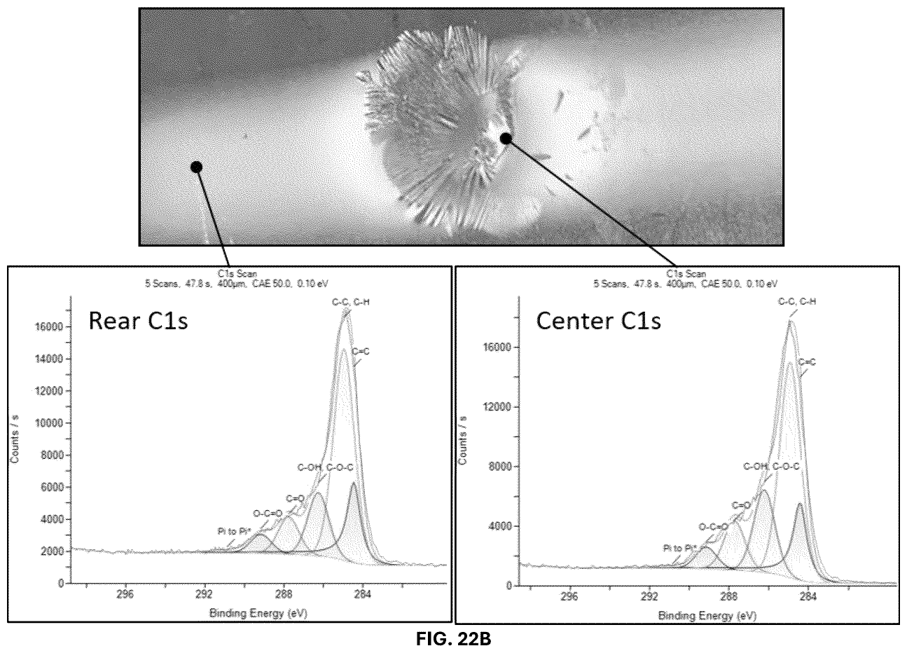

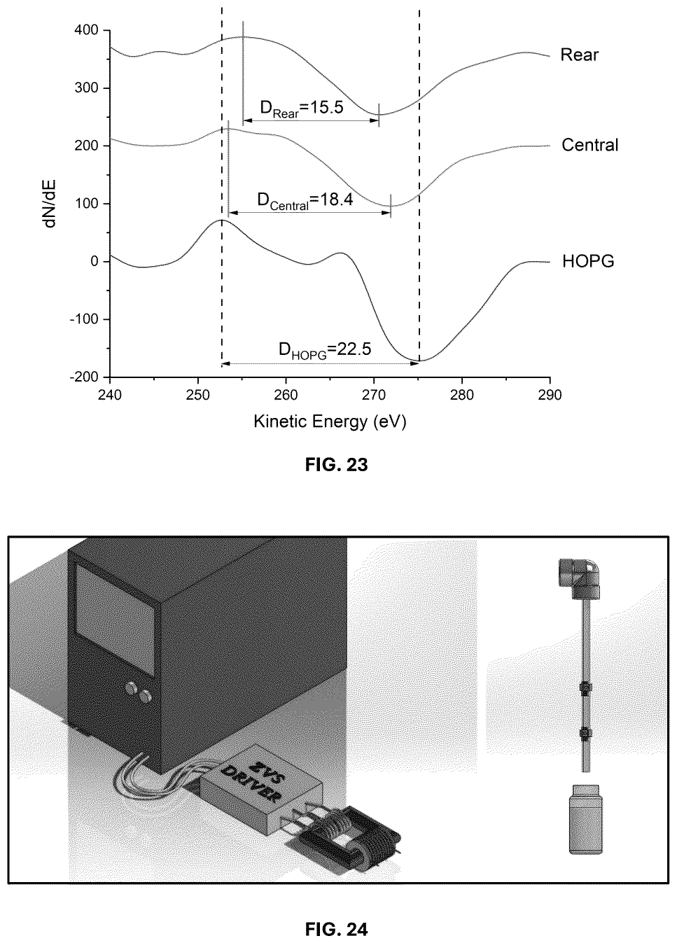

The X-ray Photoelectron Spectroscopy (XPS) and X-ray-induced Auger electron spectroscopy (XAES) characterization of an as-synthesized film is presented in FIGS. 22 and 23. FIG. 22A presents the XPS survey of the product, showing around 20% of the oxygen content, indicating that the surface or the entire film is significantly oxidized. No nitrogen or other content found indicating that the nitrogen in the air is not involved in the reaction. FIG. 22B presents the XPS C1s scans of the product on two different positions and their deconvolution results, showing the high sp3 ratio of both sampling positions. XAES result in FIG. 23 further confirms the sp3 ratio difference between the two points, showing a much higher sp3 ratio on the rear (center sample: 50% and rear sample: 85.37%). The result resembles diamond-like carbon, which has a sp3 ratio of 50%-85%.

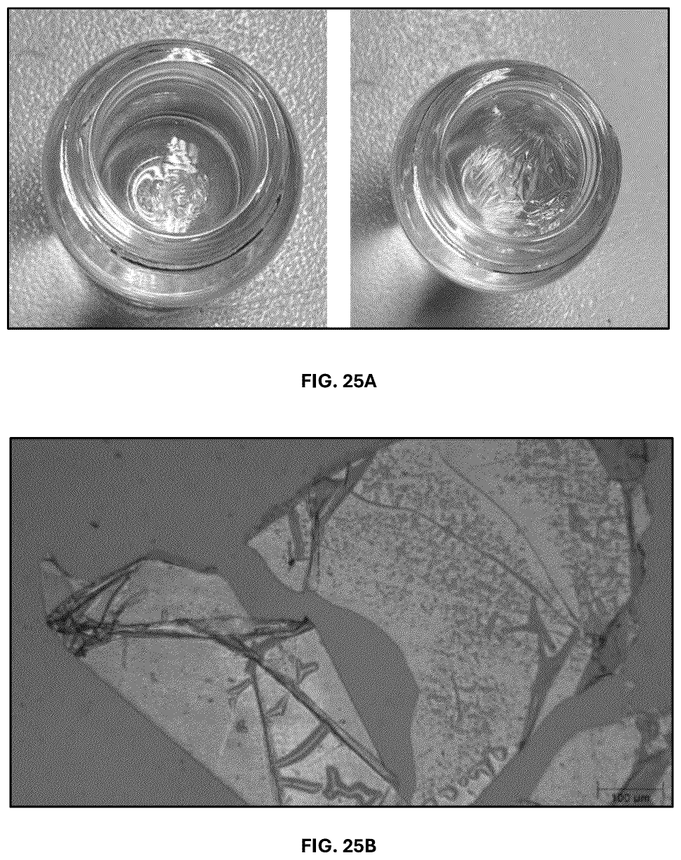

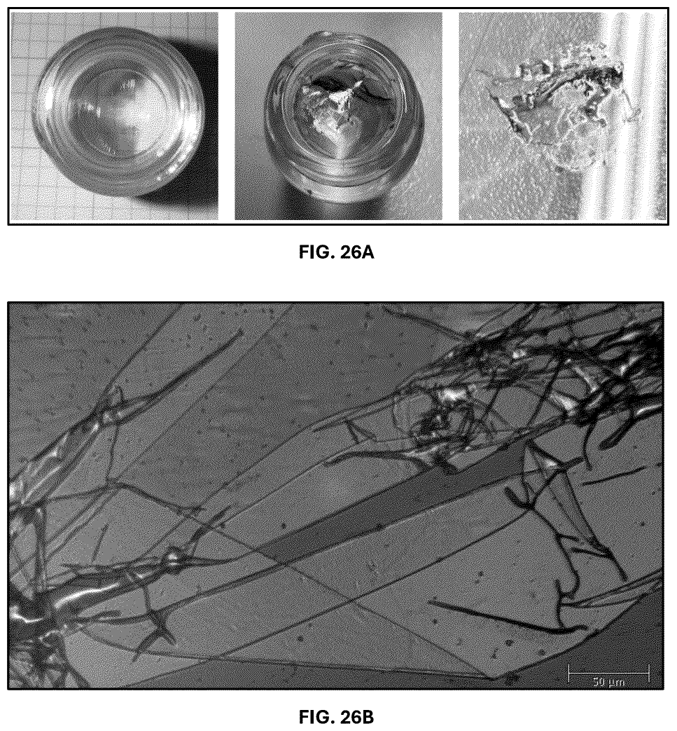

One embodiment describes the utilization of Dielectric Barrier Discharge (DBD) non-equilibrium plasma on the liquid surface for the synthesis of similar carbon-based film. The experimental setup is shown in FIG. 24. With helium as plasma gas and ethylene as precursor gas, polymer-like film could be synthesized on liquid surface, as shown in FIG. 25A. FIG. 25B shows the morphology under optical microscope. With argon as plasma gas and acetylene as precursor gas, similar product could also be synthesized as shown in FIG. 26A, and FIG. 26B shows obvious interference of light due to overlapping of the thin film, showing similarities to the flame synthesis product.

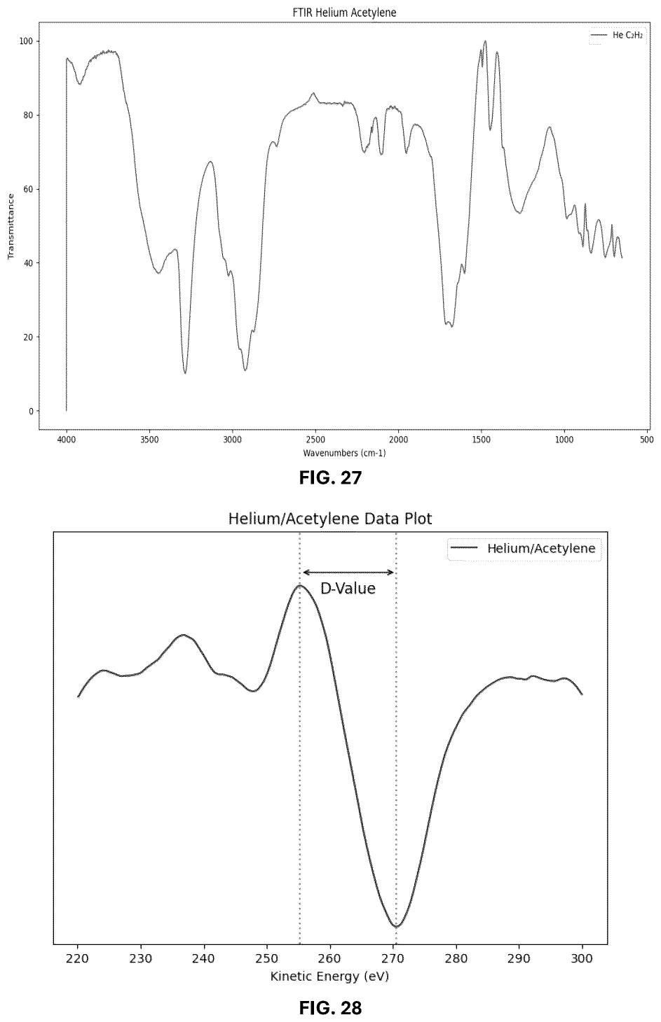

FTIR and XAES results in FIGS. 27 and 28 further demonstrate the similarities between the plasma- and flame-synthesized product, showing the major presence of sp3 hybridized carbons with oxygen-containing functional groups in the film.

The growth mechanism was investigated. Initially, the synthesis of incipient oil-like aliphatic-aromatic-linked hydrocarbons (which can be called incipient soot) is spread across the whole water surface. It may take only a few seconds for the entire water surface to be covered with it. Almost simultaneously/immediately, surface growth begins. Hydrocarbon precursors are spread over the incipient film by the stagnation flow, reacting with the film and enhancing surface growth.

Wrinkles typically occur when a thin film rests on a soft, elastic foundation (Genzer, et al. (2006) Soft Matter 2(4):310-323). Several factors can influence the formation of these wrinkles, including residual compressive stresses in the film, a difference in elastic modulus between the film and water, and external stretching and thermal contraction.

The ultra-smooth nature of the novel carbon-based film can be assessed using a universal atomistic/continuum multiscale model (Moseler, et al. (2005) Science 309(5740):1545-1548.), first applied to diamond-like carbon (DLC) films. At the atomic scale, the impact of carbon ions on the film surface generates downhill currents in the top layer of the growing film. These currents facilitate the redistribution of surface atoms, promoting local leveling. At the continuum scale, these atomic-level processes manifest as a rapid smoothing effect, where surface roughness is minimized by the erosion of elevated hills into adjacent hollows.

A number of publications and patent documents are cited throughout the foregoing specification in order to describe the state of the art to which this invention pertains. The entire disclosure of each of these citations is incorporated by reference herein.

While certain of the preferred embodiments of the present invention have been described and specifically exemplified above, it is not intended that the invention be limited to such embodiments. Various modifications may be made thereto without departing from the scope and spirit of the present invention, as set forth in the following claims.

What is claimed is:

1. A method for synthesizing a film, said method comprising reacting an oxidizer and a fuel in a burner with the flame directed at a liquid surface, thereby generating said film.

2. The method of claim 1, wherein said film is carbon-based film and said fuel is a hydrocarbon fuel.

3. The method of claim 1, wherein said film is polymeric, organic, inorganic, crystalline, and/or amorphous.

4. The method of claim 1, wherein said film comprises particles, flakes, granules, fibers, wires, and/or sheets.

5. The method of claim 1, wherein said liquid is water.

6. The method of claim 1, wherein the burner comprises a gaseous non-premixed, gaseous premixed, gaseous partially premixed, droplet spray, solid particle aerosol flame, or combination thereof burner configuration.

7. The method of claim 1, further comprising introducing an inert, dopant, and/or other reactant.

8. The method of claim 1, wherein the burner comprises non-premixed, multiple, inverse-diffusion flames, optionally staged at different levels.

9. The method of claim 8, wherein an inert, dopant, and/or other reactant is introduced at level(s) different than the first level of stabilized inverse-diffusion flames.

10. The method of claim 1, wherein the oxidizer is air or O₂, optionally with an inert.

11. The method of claim 1, wherein the oxidizer is an oxidizing agent, optionally fluorine, chlorine, bromine, or iodine.

12. The method of claim 1, wherein the fuel is a hydrocarbon, combustible liquid, combustible solid fuel, or other combustible gas.

13. The method of claim 1, wherein the fuel is also a precursor.

14. The method of claim 1, wherein a precursor is seeded into the burner.

15. The method of claim 1, wherein more than one precursor is seeded into the burner.

16. The method of claim 1, wherein the liquid surface is chemically non-participating.

17. The method of claim 1, wherein the liquid surface is chemically participating.

18. The method of claim 17, wherein the liquid surface comprises a hydrocarbon.

19. The method of claim 1, wherein the liquid surface comprises a surfactant.

20. The method of claim 1, wherein the liquid surface is modified by rotation and/or ultrasonic perturbation.

21. The method of claim 1, wherein the liquid flows beneath the burner.

22. The method of claim 1, wherein said method is in a continuous production mode.

23. The method of claim 1, wherein said film is inorganic and the method comprises an inorganic precursor, optionally with an organic precursor.

24. The method of claim 1, wherein said film ranges in thickness from angstroms to micrometers.

25. The method of claim 1, wherein said fuel is selected from the group consisting of methane, natural gas, methanol, gasoline, diesel, JP-8, and biofuels.

26. The method of claim 1, wherein another gas-phase process is utilized such as plasma, wherein the precursor is a gas, liquid, or solid.

27. The method of claim 1, where the pyrolysis vapors contain additives, thereby forming doped films.

28. The method of claim 1, wherein the film has a nanocrystalline structure.

29. The method of claim 1, wherein a non-equilibrium plasma is utilized alone or in combination with a combustion process.

30. The method of claim 1, wherein spectroscopy is used to monitor the gas-phase species profile prior to deposition such that feedback tuning of parameters can produce films with specified characteristics.
